(19) United States
(12) Patent Application Publication
(10) Pub. No.: US 2012/0023882 A1
(43) Pub. Date: Feb. 2, 2012

(54) UNIVERSAL MOUNTING STRUCTURE FOR A LAWN STRIPER

(75) Inventors: Aric Hamburg, Fond du Lac, WI (US); Jeremy F. Parsons, Huntingburg, IN (US); Michael Allen Kane, Santa Claus, IN (US); Russ J. Lannom, Mt. Juliet, TN (US)

(73) Assignee: Ariens Company

(21) Appl. No.: 13/009,721

(22) Filed: Jan. 19, 2011

Related U.S. Application Data
(63) Continuation-in-part of application No. 12/484,416, filed on Jun. 15, 2009.
Application No. 12/484,416 is a continuation-in-part of application No. 11/862,420, filed on Sep. 27, 2007, now abandoned.

(51) Int. Cl. A01D 34/00; F16M 13/02

(52) U.S. Cl. 56/14.7; 248/201

(57) ABSTRACT

One embodiment relates to a universal mounting structure for a lawn striper including a first bracket, a second bracket, a third bracket, a pin, and a spring. The first bracket is configured for mounting to a frame of a lawn mower and includes at least one aperture. The second bracket includes an aperture. The pin is received through the at least one aperture of the first bracket and through the aperture of the second bracket to rotationally couple the first bracket and the second bracket. The third bracket is rotationally coupled to the second bracket and moveable relative to the second bracket between a first position and a second position. The spring is interconnected between the second bracket and the third bracket to bias the third bracket in the first position. A longitudinal axis of the spring remains perpendicular to a longitudinal axis of the lawn mower regardless of how the first bracket is mounted to the frame of the lawn mower.

### CROSS-REFERENCE TO RELATED APPLICATIONS

This application is a Continuation-In-Part of U.S. patent application Ser. No. 12/484,416 filed Jun. 15, 2009, which is a Continuation-In-Part of U.S. patent application Ser. No. 11/862,420, filed Sep. 27, 2007, both of which are incorporated herein in their entireties.

### BACKGROUND

The present disclosure relates to the field of lawn mower accessories, and more particularly to a universal mounting structure for a lawn striper.

Lawn or grass striping is a method of grooming a mowed lawn of grass to achieve a desired aesthetic appearance. Grass striping is used to produce a checkerboard or a stripe pattern that is commonly seen in professional ball parks, golf courses, municipal parks, and even privately owned homes. The striping effect results from bending the blades of cut grass. Grass bent away from and towards the observer appears lighter and darker, respectively.

### SUMMARY

One embodiment relates to a universal mounting structure for a lawn striper including a first bracket, a second bracket, a third bracket, a pin, and a spring. The first bracket is configured for mounting to a frame of a lawn mower and includes at least one aperture. The second bracket includes an aperture. The pin is received through the at least one aperture of the first bracket and through the aperture of the second bracket to rotationally couple the first bracket and the second bracket. The third bracket is rotationally coupled to the second bracket and moveable relative to the second bracket between a first position and a second position. The spring is interconnected between the second bracket and the third bracket to bias the third bracket in the first position. A longitudinal axis of the spring remains perpendicular to a longitudinal axis of the lawn mower regardless of how the first bracket is mounted to the frame of the lawn mower.

Another embodiment relates to a lawn mower having a lawn striper including a first bracket, a second bracket, a pin that rotationally couples the first bracket and the second bracket, a third bracket, a spring, and a striper blade. The first bracket is configured for mounting to a frame of the lawn mower and includes at least one aperture. The second bracket includes an aperture. The pin is received through the at least one aperture of the first bracket and through the aperture of the second bracket to rotationally couple the first bracket and the second bracket. The third bracket is rotationally coupled to the second bracket and moveable relative to the second bracket between a first position and a second position. The spring is interconnected between the second bracket and the third bracket to bias the third bracket in the first position. The striper blade includes an upper edge coupled to the third bracket and a free lower edge opposite the upper edge. The upper edge of the striper blade remains perpendicular to a longitudinal axis of the lawn mower regardless of how the first bracket is mounted to the frame of the lawn mower.

Another embodiment relates to a lawn striping kit including at least one universal mounting structure. The universal mounting structure includes a first bracket, a second bracket, a third bracket, a first pin, a second pin, and a spring. The first bracket is configured for mounting to a frame of a lawn mower and includes a first aperture in a first surface of the bracket and a second aperture in a second surface of the bracket. The first surface and the second surface are perpendicular to one another. The second bracket includes an aperture. The third bracket is rotationally coupled to the second bracket and moveable relative to the second bracket between a first position and a second position. The spring is interconnected between the second bracket and the third bracket to bias the third bracket in the first position. The first pin is configured to be received through the first aperture of the first bracket and the aperture of the second bracket to rotationally couple the first bracket and the second bracket when the universal mounting structure is in a first orientation. The second pin is configured to be received through the second aperture of the first bracket and the aperture of the second bracket to rotationally couple the first bracket and the second bracket when the universal mounting structure is in a second orientation.

### BRIEF DESCRIPTION OF THE DRAWINGS

These and other attributes of the disclosure will become more clear upon a thorough study of the following description of the best mode for carrying out the disclosure, particularly when reviewed in conjunction with the drawings.

FIG. 1 is a perspective view showing the grass striper of the present disclosure mounted at the rear of a lawn mower.

FIG. 2 is a side elevational view of the lawn mower of FIG. 1.

FIG. 3 is an exploded perspective view showing the components of the grass striper.

FIG. 4 is an enlarged elevational view of the coil spring resilient link, with portions cut away to show the top and bottom spring connectors.

FIG. 5 is a sectional view taken along line 5-5 of FIG. 4.

FIG. 6 is a partial side elevational view showing the top edge of the wiper blade at a selected elevation above the ground surface.

FIG. 7 is a view similar to FIG. 6, but showing the top edge of the wiper blade at a lower elevation, where more of the lower portion of the wiper blade is flexed downwardly in contact with the ground surface.

FIG. 8 is a partial side elevational view of an alternate embodiment of the grass striper using a tension spring resilient link and a molded wiper blade including spring steel molded inserts.

FIG. 9 is an exploded perspective view showing the components of the grass striper alternate embodiment;

FIG. 10 is a front elevational view of the wiper blade with the location of the spring steel inserts shown in dashed lines.

FIG. 11 is a front elevational view of the spring steel insert.

FIG. 12 is a sectional view taken along line 12-12 of FIG. 10.

FIG. 13 is an enlarged perspective view of the torsion spring linkage.

FIGS. 14A and 14B are exploded views of a grass striper according to another exemplary embodiment.

FIG. 15 is an exploded view of the spring assembly of FIG. 14A.

FIG. 16 is a top view of a the grass striper of FIG. 14A coupled to a lawnmower.

FIGS. 17-20 are perspective views of the grass striper of FIG. 14 coupled to a lawnmower in various configurations.

### DETAILED DESCRIPTION

As can be seen by reference to the drawings, and in particular to FIG. 1, the grass striper that forms the basis of the present disclosure is designated generally by the reference number 10. The grass striper 10 includes an elongated flexible wiper blade 20 and a resilient link 40. FIG. 1 shows the striper 10 attached to the frame of a lawn mower 1 behind the mower deck 3 and behind the rear ground wheels 5.

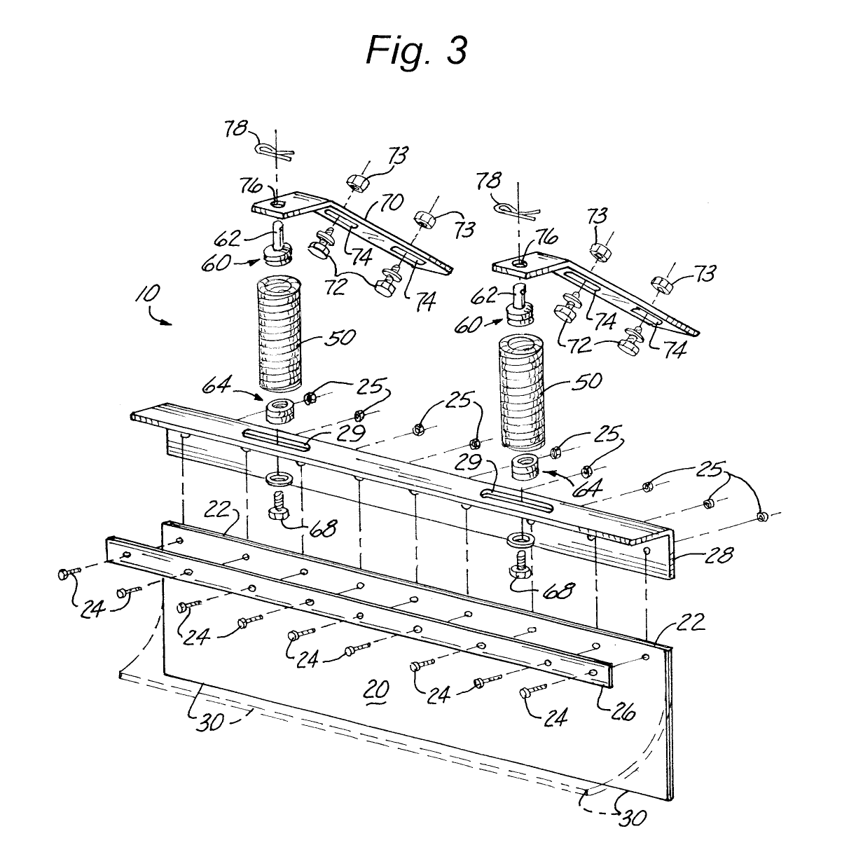

As best shown in FIG. 3, the wiper blade 20 has an upper edge 22 attached by fasteners 24, 25 between a mounting bar 26 and the lower arm of an angle bracket 28. The lower edge 30 of the blade 20 is disposed to contact the ground surface 7 and extends transversely a distance greater than the distance between the rear wheels 5 of the mower 1. Slots 29 in the upper arm of the angle bracket 28 allow for transverse adjustment of the position of the wiper blade 20. The wiper blade 20 is made of a multi-ply rubber sheet generally used in conveyor belts. The preferred material includes a polyester fabric and has an elastic modulus ranging from 20,000 to 40,000 piw, e.g., Goodyear-Spartan conveyor belting. The wiper blade 20 is flexible, but provides adequate stiffness to bend the cut grass behind the mower 1. Also, the lower corners of the blade 20 may be rounded to prevent the blade from gouging the ground surface 7.

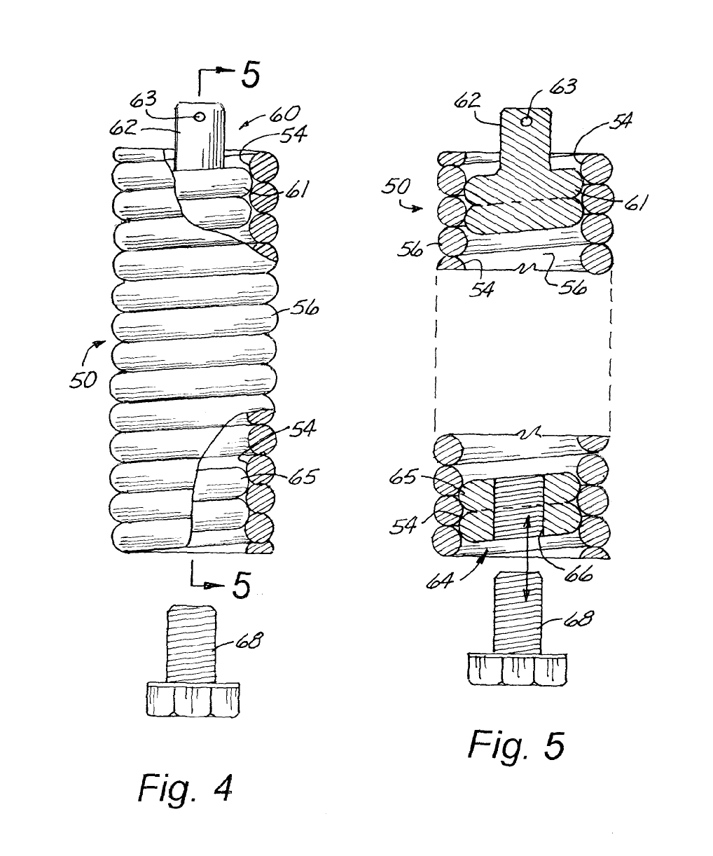

The resilient link 40 includes a pair of transversely spaced coil springs 50 attached to and interconnecting the upper arm of the angle bracket 28 and vertically adjustable brackets 70. FIGS. 4 and 5 show the coil spring 50 with an outer surface 52, and an inner surface 54 that defines a central core 56. Top and bottom spring connectors 60 and 64 have outer surfaces 61 and 65 that thread into the central core 56 and matingly engage the inner surface 54. A lug 62 with an opening 63 extends up from the top connector 60, and a threaded bore 66 is formed in the bottom connector 64 to receive fastener 68.

Vertically adjustable brackets 70 are secured to the frame of the mower 1 by fasteners 72, 73 received in adjustment slot 74. The lug 62 of top spring connector 60 is received through an opening 76 in bracket 70 and secured by cotter pin 78. Fastener 68 is received through adjustment slot 29 in angle bracket 28 to secure the bottom spring connector 64 to bracket 28. The wiper blade 20 is thus attached to the mower by the resilient link 40.

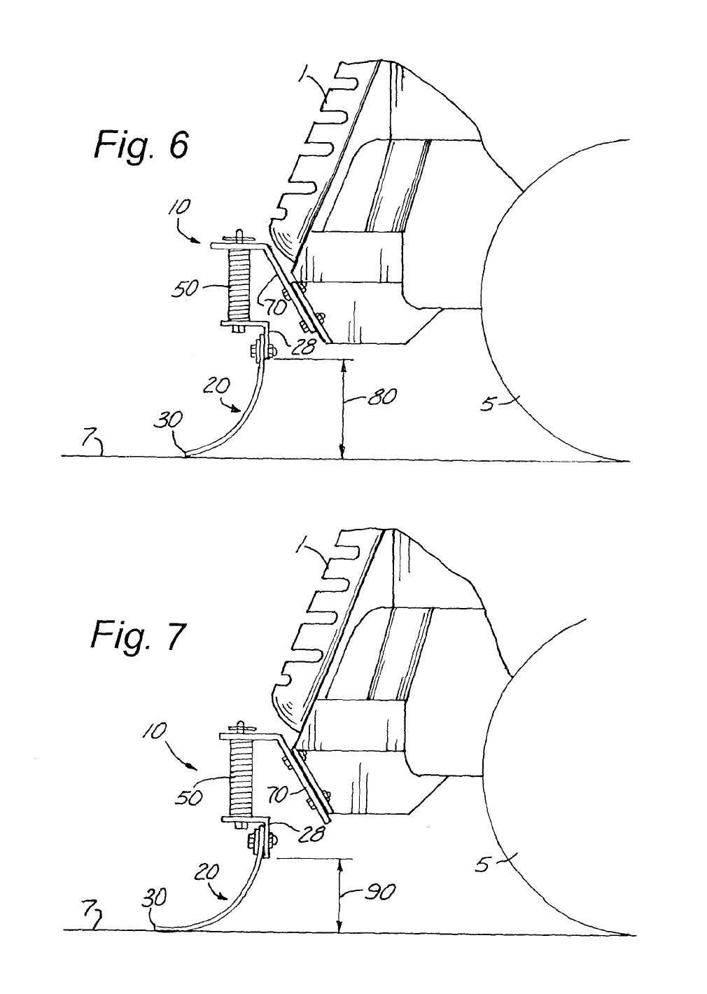

FIGS. 6 and 7 illustrate the vertical adjustment of the wiper bade 20 with respect to the ground surface 7. FIG. 6 shows the top portion of the blade 20 at a first elevation 80 above the ground surface 7, and FIG. 7 shows the top portion of the blade 20 at a second lower elevation 90, where more of the lower portion of the blade 20 flexes to contact the ground surface 7 and provide greater force to bend the grass in the direction of travel of the mower 1. The elevation of the upper portion of the blade 20 is selectively adjusted based on the type of grass to be groomed.

The grass striper 10 of the present disclosure is designed to be attached to most lawn mowers behind the mower deck to create a striping effect on the mowed lawn. The adjustable bracket 70 may take any configuration necessary to mount to a given mower. This striper 10 is lightweight and does not compact the ground like heavy rollers commonly used for striping. This striper 10 is resiliently mounted to provide maximum flexibility, and is vertically adjustable to be effectively used with many varieties of grasses.

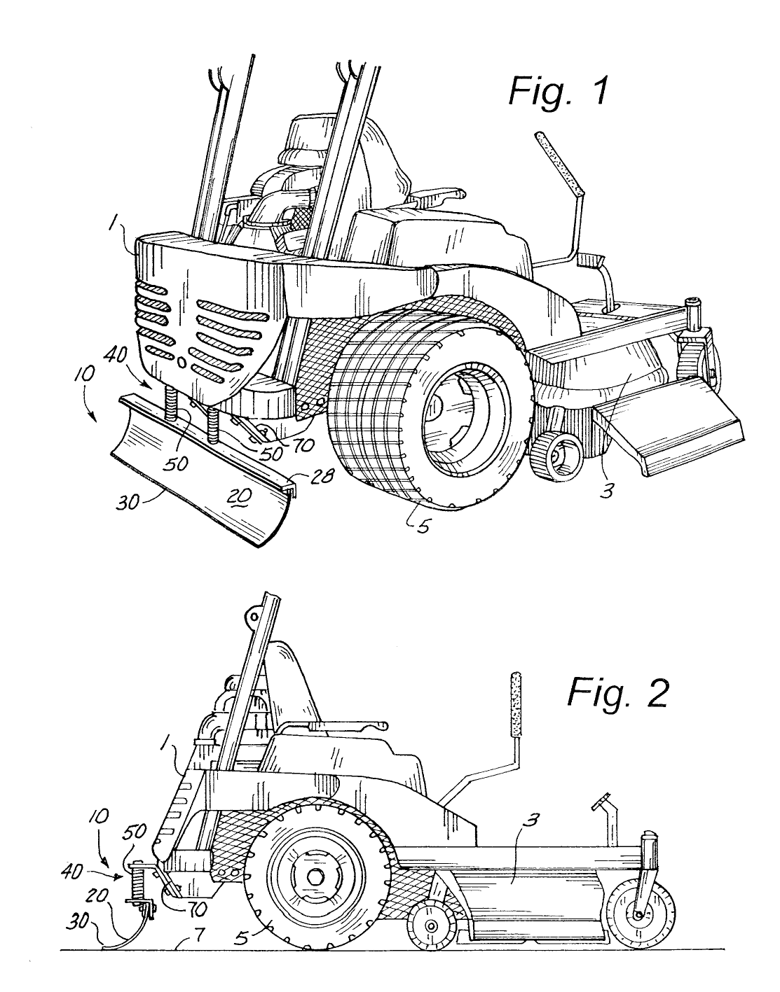

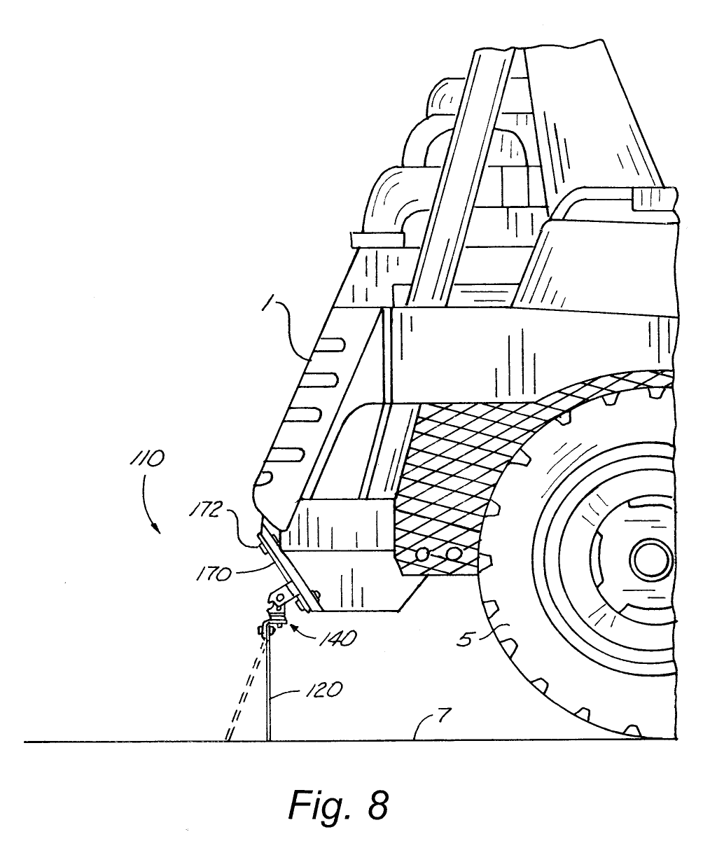

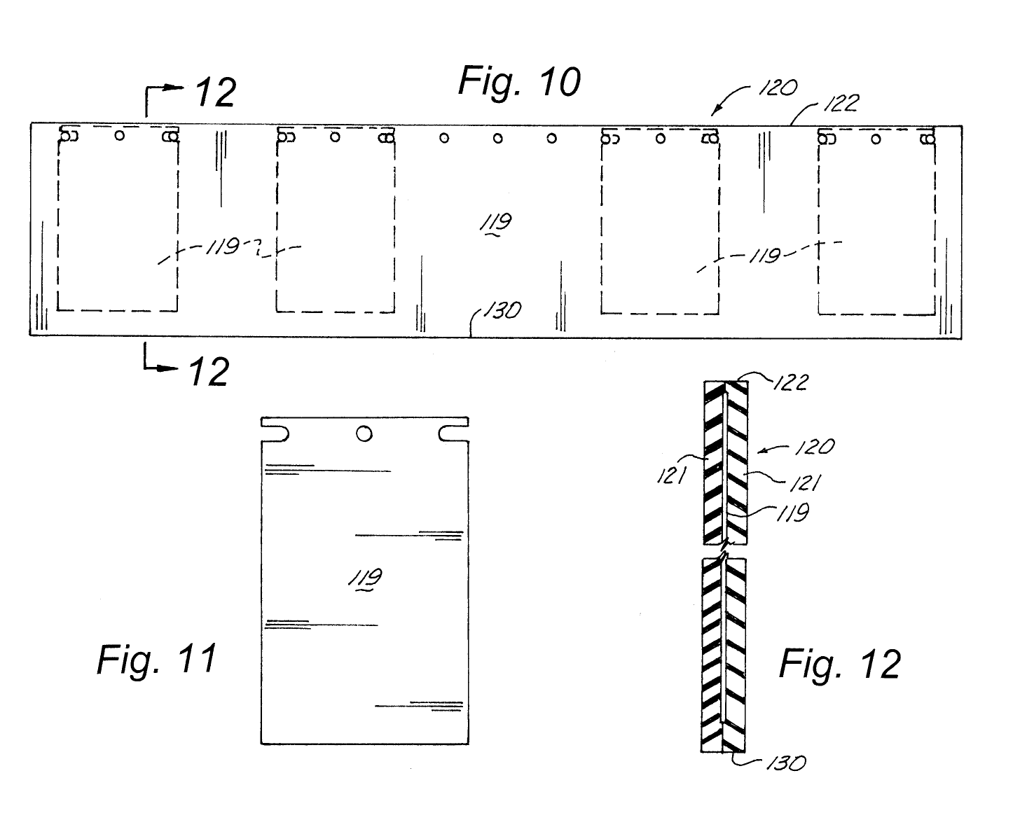

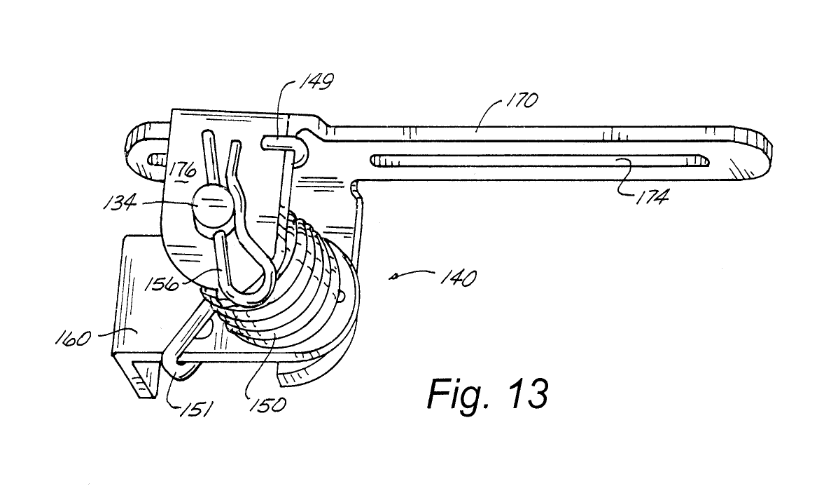

An alternate embodiment grass striper 110 is illustrated in FIGS. 8-13. The grass striper 110 includes an elongated flexible wiper blade 120 and a resilient link 140. The grass striper 110 is attached to the frame of a lawn mower 1 in a manner similar to the attachment of the grass striper 10 illustrated in FIGS. 1 and 2.

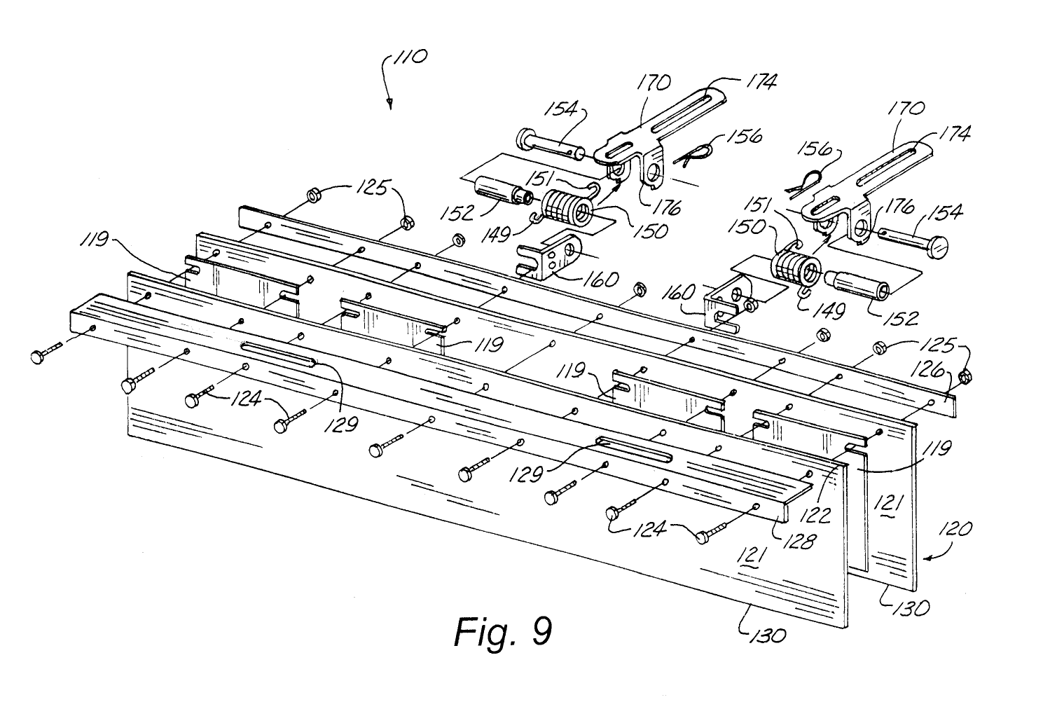

As best shown in FIG. 9, the wiper blade 120 has an upper edge 122 attached by fasteners 124, 125 between a mounting bar 126 and the lower arm of an angle bracket 128. The lower edge 130 of the blade 120 is disposed to contact the ground surface 7 and extends transversely a distance greater than the distance between the rear wheels 5 of the mower 1. Slots 129 in the upper arm of angle bracket 128 allow for transverse adjustment of the position of the wiper blade 120.

The wiper blade 120 is a laminate including four spaced spring steel inserts 119 sandwiched between a pair of rubber strips 121. The preferred embodiment of the wiper blade 120 is made by placing the first rubber strip 121 in a preheated molding die, positioning four spaced spring steel inserts 119 on the first rubber strip 121, then placing the second rubber strip 121 over the inserts 119. The die is then closed and vulcanization is started, curing the rubber with high heat and sulfur. The die is then opened and the cured laminated wiper blade 120 is removed. Each of the rubber strips 121 is 1030 mm long, 230 mm wide, and 4.75 mm thick, and are composed of 25% Nitrile butadiene rubber (NBR), 50% Natural rubber (NR), and 25% cotton yarn. The spring steel inserts 119 are 0.50 mm thick spring steel. The wiper blade 120 is flexible, but it is substantially stiffer than wiper blade 20.

The resilient link 140 includes a pair of transversely spaced torsion springs 150 attached to and interconnecting the upper arm of the angle bracket 128 and vertically adjustable brackets 170 that are attached to the frame of the mower 1 by fasteners 172 received in adjustment slots 174. The torsion spring 150 is carried on a sleeve 152, and pin 154 and cotter key 156 secure the spring 150 to the lower yoke 176 of the adjustable bracket 170. Connecting bracket 160 is carried on the reduced end of sleeve 152 between the torsion spring 150 and the yoke 176 of the adjustment bracket 170. One end 149 of the torsion spring 150 engages the yoke 176 of the adjustment bracket 170 while the opposite end 151 of the spring 150 engages the connecting bracket 160.

The wiper blade 120 is vertically adjustable in a manner similar to the adjustment of wiper blade 20 illustrated in FIGS. 6 and 7. Also, the wiper blade 120 may be attached to most mowers behind the mower deck and be used on many varieties of grasses.

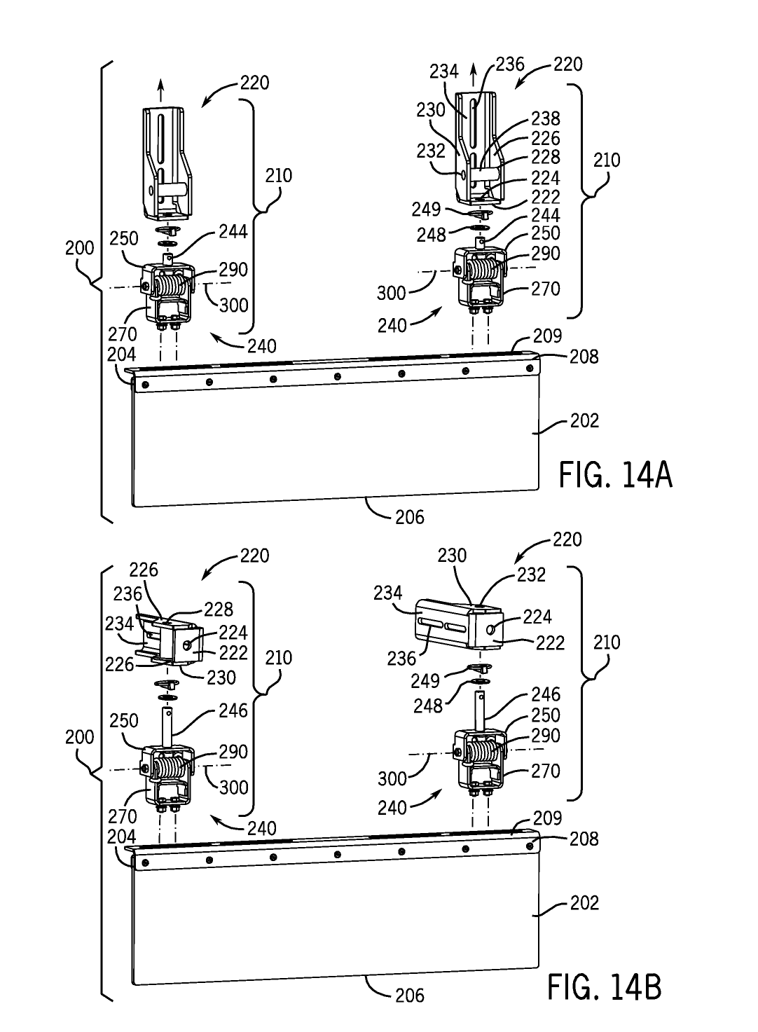

Referring now to FIGS. 14A and 14B, a striper 200 (e.g. striper assembly, lawn striper, grass striper, etc.) is shown according to another exemplary embodiment. The striper 200 includes a blade 202 with an upper edge 204 and a lower edge 206. As described above, the blade 202 may be a resilient material such as a fabric, a flexible polymer, a rubber (e.g., such as a masticated rubber), or a silicone. In other embodiments, the blade 202 may be formed of a generally rigid material such as a rigid polymer, steel, or another metal.

The blade 202 is coupled to a lawn mower 310 via one or more mounting devices, shown in FIGS. 14A, 14B, and FIG. 16 as two universal mounting structures 210. As shown in FIGS. 16-20, the universal mounting structures 210 couple the blade 202 to the frame 311 of the lawn mower 310 generally to the rear of the rear wheels 312. A bracket 208 with one or more openings 209 is provided along the upper edge 204 of the blade 202. In one embodiment, the openings 209 may be slots to allow for a greater flexibility in the positioning of the universal mounting structures 210. In one embodiment, the bracket 208 has an L-shaped cross-section and is coupled to the blade 202 with fasteners such as bolts, rivets, or a welded connection. In other embodiments, the bracket 208 may have another cross-sectional shape such as an I-shaped cross-section, a T-shaped cross-section, a U-shaped cross-section, or other suitable cross-sectional shape. In other embodiments, the upper edge 204 of the blade 202 may be shaped (e.g., with a lip, etc.) and include openings 209 such that the universal mounting structures 210 may be coupled directly to the blade 202.

According to an exemplary embodiment, each universal mounting structure 210 includes a first bracket 220, a second bracket 250, and a third bracket 270. The second bracket 250 and the third bracket 270 are coupled together in a manner that allows the second bracket 250 and the third bracket 270 to move (e.g., rotate) relative to one another. As shown in FIGS. 14A and 14B, a resilient member, shown as a spring 290, is coupled to both the second bracket 250 and the third bracket 270. The spring 290 biases the rotational position of third bracket 270 relative to the second bracket 250. According to an exemplary embodiment, the spring 290 is a torsion spring.

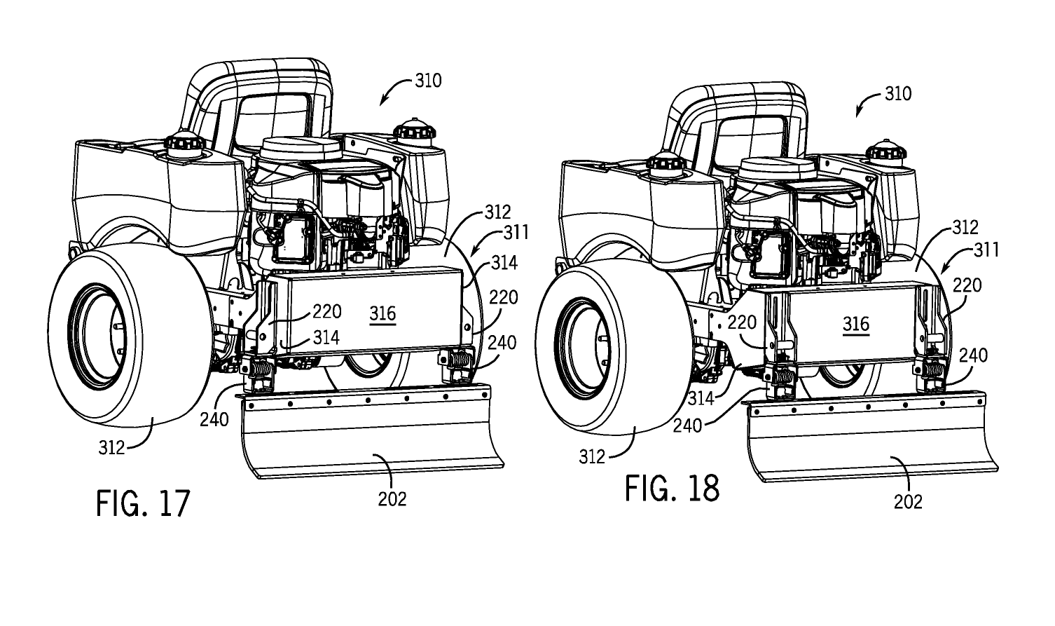

The second bracket 250, the third bracket 270, and the spring 290 form an assembly shown as a spring box assembly 240. The first bracket 220, along with the spring box assembly 240, are coupled together to mount the blade 202 to the lawn mower 310. As shown in FIGS. 17-20, the first bracket 220 is coupled to the frame 311 of the lawn mower 310 and third bracket 270 is coupled to the upper edge 204 of the blade 202 (e.g., via the bracket 208).

The first bracket 220 includes first surface 222, a second surface 226, and a third surface 230. The second surface 226 and the third surface 230 are generally perpendicular to the first surface 222. The second surface 226 and the third surface 230 are parallel to one another and spaced apart from each other. The first surface 222 includes a first aperture 224. A second aperture 228 is provided in the second surface 226, and a corresponding third aperture 232 is provided in the third surface 230. According to an exemplary embodiment, the third aperture 232 is generally aligned with the second aperture 228. A hollow support member 238 may be coupled (e.g., welded) to the second surface 226 and the third surface 230, aligned with both the second aperture 228 and the third aperture 232.

The first aperture 224, the second aperture 228, and the third aperture 232 are each configured to receive a member for coupling the first bracket 220 to the spring box assembly 240. According to one embodiment, shown in FIG. 14A, the first bracket 220 is in a generally vertical orientation and the spring box assembly 240 is coupled to the first surface 222 of the first bracket 220 with a pin 244 received in the first aperture 224. According to another exemplary embodiment, shown in FIG. 14B, the first bracket 220 is in a generally horizontal orientation and the spring box assembly 240 is coupled to the second surface 226 or the third surface 230 of the first bracket 220 with a pin 246. The pin 246 is received in the second aperture 228 and the third aperture 232 and passes through the hollow support member 238. A washer 248 and a fastener such as a linchpin 249 may be utilized to secure the pin 244 or the pin 246. In other exemplary embodiments, the pin 244 or 246 may be secured with another device such as a cotter pin, R-clip, or split pin. In still other embodiments, the pin 244 or 246 may be partially threaded and be secured with a nut. In still other embodiments, the pin 244 or 246 may be a fixed post extending from the first bracket 220 or the spring box assembly 240.

In other exemplary embodiments, the support member 238 may not be aligned with the second aperture 228 and the third aperture 232. In such an embodiment, the first bracket 220 may be in a generally horizontal orientation, and the spring box assembly 240 may be coupled to the first bracket 220 with a shorter fastener, similar to pin 244, that only passes through the second aperture 228 or the third aperture 232. The spring box assembly 240 may also be coupled to the first bracket 220 with a pin 246 that is long enough to pass through both the second aperture 228 and the third aperture 232 without passing through the support member 238.

The first bracket 220 further includes a fourth surface 234 that is perpendicular to the first surface 222, the second surface 226, and the third surface 230. When the first bracket 220 is coupled to the frame 311, the fourth surface 234 is adjacent to the frame 311. The fourth surface 234 includes one or more openings 236 configured to receive a fastener, such as a threaded fastener. The openings 236 are configured to allow a wide variety of fastener locations, thereby allowing greater flexibility in the placement of the first bracket 220 on the frame 311 of the lawn mower 310. In one embodiment, each opening 236 is a slot, but in other embodiments, the openings 236 may include a single slot, one or more holes, a combination of slots and holes, or any other suitable openings.

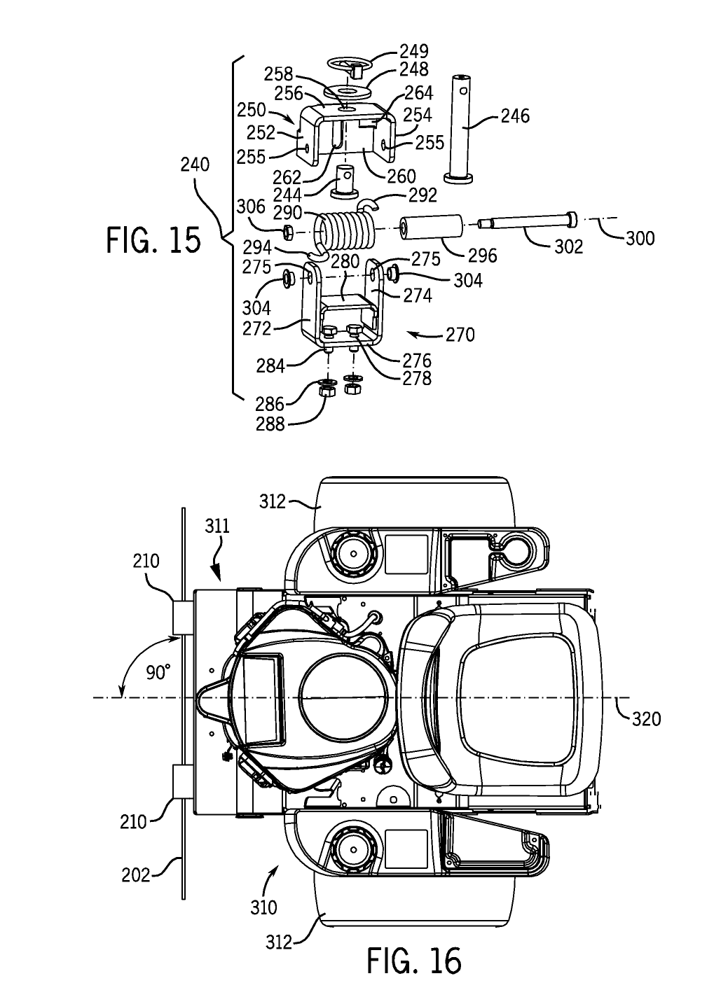

Referring now to FIG. 15, the spring box assembly 240 formed by the second bracket 250, the third bracket 270, and the spring 290 is shown according to an exemplary embodiment. The second bracket 250 includes a first arm 252 and a second arm 254 that are spaced apart from one another and are substantially parallel to each other. The first arm 252 and the second arm 254 extend generally at a right angle from a surface 256. According to an exemplary embodiment, the surface 256 includes an aperture 258 for receiving a coupling member, such as pin 244 or pin 246.

The second bracket 250 may further include a second surface 260 that is perpendicular to the first arm 252, the second arm 254, and the surface 256. The second surface 260 may include one or more openings 262 such as slots or holes. According to an exemplary embodiment, the first bracket 220 may not be used and the openings 262 may be used to couple the spring box assembly 240 directly to the frame 311.

According to an exemplary embodiment, the third bracket 270 includes a first arm 272 and a second arm 274 that are spaced apart from one another and are substantially parallel to each other. The first arm 272 and the second arm 274 extend generally at a right angle from a surface 276. According to an exemplary embodiment, the surface 276 includes one or more apertures 278 for receiving one or more coupling members, such as bolts 284. The bolts 284 may cooperate with washers 286 and nuts 288 to couple the third bracket 270 to the bracket 208 (e.g., using the openings 209 in the bracket 208), thus coupling the universal mounting structure 210 to the blade 202. The use of two fasteners such as bolts 284 to couple the third bracket 270 to the bracket 208 rotationally fixes the third bracket 270 to the bracket 208.

According to an exemplary embodiment, the third bracket 270 may further include one or more support members 280. The support member 280 may be a planar member as shown in FIG. 15, a hollow member similar to support member 238 of the first bracket 220, or any other suitable support member. As shown in FIG. 15, the support member 280 extends between the first arm 272 and the second arm 274 and is coupled (e.g., welded) to each of the arms 272, 274 at an end of the support member 280.

According to an exemplary embodiment, the first arm 252 and the second arm 254 of the second bracket 250 include generally aligned apertures 255. Likewise, the first arm 272 and the second arm 274 of the third bracket 270 include generally aligned apertures 275. When the spring box assembly 240 is assembled, the spring 290 is aligned with the apertures 255 and the apertures 275. A first end 292 of the spring 290 is coupled to the second bracket 250 and a second end 294 of the spring 290 is coupled to the third bracket 270. According to one exemplary embodiment, the ends 292 and 294 of the spring 290 are wrapped on or around the edges of the respective brackets 250 and 270. According to another exemplary embodiment, the ends 292 and 294 of the spring 290 are received in apertures in the respective brackets 250 and 270. Additionally, according to another exemplary embodiment, the end 292 may be received in an aperture in the second bracket 250 (such as, e.g., aperture 264 shown in FIG. 15) and the end 294 may be wrapped around a front portion of the end of the arm 272 of the third bracket 270.

According to an exemplary embodiment, the spring 290 may surround a hollow member such as a bushing 296. A pivot member, shown as a bolt 302, passes through the apertures 255, through the apertures 275, through the bushing 296, and through the spring 290 along the longitudinal axis 300 of the spring 290. One or more bushing washers 304 and a nut 306 may be used to retain the bolt 302. The bolt 302 couples the second bracket 250 to the third bracket 270 such that the third bracket 270 can rotate about the longitudinal axis 300 relative to the second bracket 250. In other words, the third bracket 270 is rotationally coupled to the second bracket 250. The bolts 284 prevent the third bracket 270 from rotating relative to the bracket 208. In this way, the longitudinal axis 300 of the springs 290 of each of the spring box assemblies 240 remains parallel to each other and to the blade 202.

Once the spring box assembly 240 is assembled, the spring 290 applies a force (e.g., a biasing force) between the second bracket 250 and the third bracket 270. In other words, the spring 290 exerts a biasing force on the third bracket 270 such that the third bracket 270 is normally in a first or rest position (e.g., such that the surface 256 of the second bracket 250 is generally parallel to the surface 276 of the third bracket 270). During operation of the grass striper, the third bracket 270 may be rotated to a second or operative position when the blade 202 is in use to stripe grass. In this manner, the spring 290 aids in applying a force to the lower edge 206 of the blade 202 such that contact is maintained between the blade 202 and the ground.

If viewed from the right side of the lawn mower 310, the spring 290 biases the third bracket 270 and the blade 202 in a clockwise direction relative to the second bracket 250 about the longitudinal axis 300 of the spring 290. When in use, the lawn mower 310 may pass over bumps, ridges, or other features that apply an upward force on the lower edge 206 of the blade 202, causing the blade 202 and the third bracket 270 in an anti-clockwise direction relative to the second bracket 250 about the longitudinal axis 300 of the spring 290. This force is counteracted by the spring 290 to maintain contact between the blade 202 and the ground.

According to other exemplary embodiments, another type of resilient member may be used to bias the rotation of the third bracket 270 and the blade 202 relative to the second bracket 250 and the frame 311. For instance, the spring 290 may be a tubular rubber member, a leaf spring, a compression spring, an extension spring, or any other suitable member.

Referring to FIG. 16, the universal mounting structures 210 are used to couple the blade 202 to the lawn mower 310 such that the blade 202 is perpendicular to the forward movement of the lawn mower 310 (e.g., the blade 202 is perpendicular to the longitudinal axis 320 of the lawn mower 310).

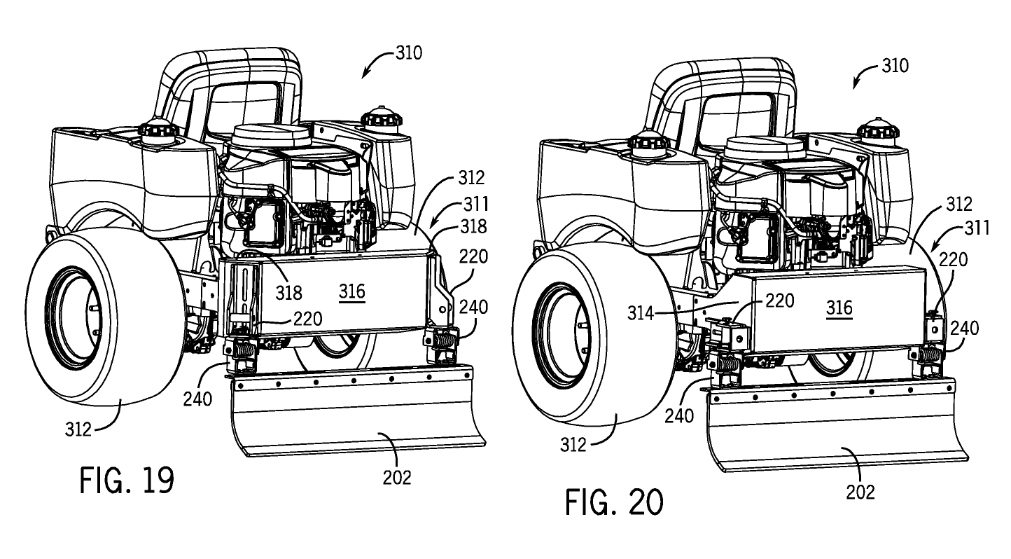

The connection between the first bracket 220 and the spring box assembly 240 allows the spring box assembly 240 to rotate relative to the first bracket 220 (e.g., via pin 244 or pin 246) during assembling the blade 202 to the mower 310 (i.e., before the blade 202 is coupled to both of the third brackets 270). This allows the spring box assembly 240 to remain in the same orientation (e.g., with the longitudinal axis 300 of the spring 290 parallel to the blade 202 and perpendicular to the longitudinal axis 320 of the lawn mower 310) regardless of whether the first bracket 220 is coupled to a side face 314 of the frame 311 (e.g., as shown in FIG. 17), to a rear face 316 of the frame 311 (e.g., as shown in FIG. 18), or to an angled face 318 of the frame 311 (e.g., as shown in FIG. 19). It should be noted that the angled face 318 may have any angle between the rear face 316 and the side face 314. In other words, the angle face 318 may be angled from between 0 degrees and 90 degrees.

Further, as shown in FIG. 20, the spring box assembly 240 may be coupled to the first bracket 220 oriented horizontally along any vertical surface, such as side face 314 (e.g., as shown in FIG. 20). Likewise, the spring box assembly 240 may be coupled to the first bracket 220 oriented horizontally along the rear face 316 or the angled face 318 (both of which are not shown).

The flexible nature of the universal mounting structures 210 allow the blade 202 to be coupled to a wide variety of lawn mowers of different makes and models. The blade 202 and universal mounting structures 210 may be provided as a kit, allowing a lawn mower dealer or purchaser to add lawn striping functionality to an already existing lawn mower.

As shown in FIGS. 17-20, the blade 202 can be coupled to the lawn mower 310 with the universal mounting structures 210 in many different orientations. However, it should be noted that one having ordinary skill in the art would readily recognize that many other different orientations are possible, and not just limited to those shown in FIGS. 17-20.

As utilized herein, the terms “approximately,” “about,” “substantially,” and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the invention as recited in the appended claims.

It should be noted that the term “exemplary” as used herein to describe various embodiments is intended to indicate that such embodiments are possible examples, representations, and/or illustrations of possible embodiments (and such term is not intended to connote that such embodiments are necessarily extraordinary or superlative examples).

The terms “coupled,” “connected,” and the like as used herein mean the joining of two members directly or indirectly to one another. Such joining may be stationary (e.g., permanent) or moveable (e.g., removable or releasable). Such joining may be achieved with the two members or the two members and any additional intermediate members being integrally formed as a single unitary body with one another or with the two members or the two members and any additional intermediate members being attached to one another.

It is important to note that the construction and arrangement of the universal mounting structures shown in the various exemplary embodiments is illustrative only. Although only a few embodiments have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter described herein. For example, elements shown as integrally formed may be constructed of multiple parts or elements, the position of elements may be reversed or otherwise varied, and the nature or number of discrete elements or positions may be altered or varied. The order or sequence of any process or method steps may be varied or re-sequenced according to alternative embodiments. Other substitutions, modifications, changes and omissions may also be made in the design, operating conditions and arrangement of the various exemplary embodiments without departing from the scope of the present invention.

What is claimed:

1. A universal mounting structure for a lawn striper comprising:
a first bracket configured for mounting to a frame of a lawn mower and having at least one aperture defined therein;
a second bracket having an aperture defined therein;
a pin received through the at least one aperture of the first bracket and through the aperture of the second bracket to rotationally couple the first bracket and the second bracket;
a third bracket rotationally coupled to the second bracket and moveable relative to the second bracket between a first position and a second position; and
a spring interconnected between the second bracket and the third bracket to bias the third bracket in the first position, wherein a longitudinal axis of the spring remains perpendicular to a longitudinal axis of the lawn mower regardless of how the first bracket is mounted to the frame of the lawn mower.

2. The universal mounting structure of claim 1, further comprising an elongated flexible striper blade having an upper edge coupled to the third bracket and a free lower edge opposite the upper edge.

3. The universal mounting structure of claim 1, wherein the first bracket comprises a first surface having a first aperture and a second surface having a second aperture, wherein the first surface and the second surface are perpendicular to one another.

4. The universal mounting structure of claim 3, wherein the first bracket comprises a third surface spaced apart from and substantially parallel to the second surface, the third surface having a third aperture generally aligned with the second aperture.

5. The universal mounting structure of claim 4, wherein the first bracket comprises a hollow support member interconnecting the second and third apertures.

6. The universal mounting structure of claim 4, further comprising a fourth surface coupled to an edge of each of the first, second, and third surfaces, the fourth surface comprising at least one opening configured to receive a fastener for coupling the first bracket to the frame of the lawn mower.

7. The universal mounting structure of claim 1, wherein the second bracket comprises a pair of spaced apart and substantially parallel arms, each of the arms extending from a surface of the second bracket, the surface defining the aperture of the second bracket.

8. The universal mounting structure of claim 7, wherein the third bracket comprises a pair of spaced apart and substantially parallel arms, an end of each of the arms of the third bracket rotationally coupled to an end of one of the arms of the second bracket.

9. The universal mounting structure of claim 8, wherein the third bracket comprises a surface extending between the pair of arms, the surface comprising at least one aperture configured to receive a fastener for coupling the third bracket to a striper blade.

10. The universal mounting structure of claim 9, wherein the third bracket comprises a support member coupled to and extending between the pair of arms.

11. The universal mounting structure of claim 1, wherein the spring is a torsion spring.

12. A lawn mower having a lawn striper, the lawn striper comprising:
a first bracket configured for mounting to a frame of the lawn mower and having at least one aperture defined therein;
a second bracket having an aperture defined therein;
a pin received through the at least one aperture of the first bracket and through the aperture of the second bracket to rotationally couple the first bracket and the second bracket;
a third bracket rotationally coupled to the second bracket and moveable relative to the second bracket between a first position and a second position;
a spring interconnected between the second bracket and the third bracket to bias the third bracket in the first position; and
a striper blade having an upper edge coupled to the third bracket and a free lower edge opposite the upper edge, wherein the upper edge of the striper blade remains perpendicular to a longitudinal axis of the lawn mower regardless of how the first bracket is mounted to the frame of the lawn mower.

13. The lawn striper of claim 12, wherein the first bracket comprises a first surface having a first aperture and a second surface having a second aperture, wherein the first surface and the second surface are perpendicular to one another.

14. The lawn striper of claim 13, wherein the pin is configured to be received through the first aperture of the first bracket when the first bracket is in a first orientation and wherein the pin is configured to be received through the second aperture of the first bracket when the first bracket is in a second orientation.

15. The lawn striper of claim 12, wherein the striper blade is an elongated flexible striper blade.

16. The lawn striper of claim 15, wherein the striper blade comprises rubber.

17. A lawn striping kit comprising:
at least one universal mounting structure comprising:
a first bracket configured for mounting to a frame of a lawn mower and comprising a first aperture in a first surface of the bracket and a second aperture in a second surface of the bracket, wherein the first surface and the second surface are perpendicular to one another;
a second bracket having an aperture defined therein;
a first pin and a second pin;
a third bracket rotationally coupled to the second bracket and moveable relative to the second bracket between a first position and a second position; and
a spring interconnected between the second bracket and the third bracket to bias the third bracket in the first position;
wherein the first pin is configured to be received through the first aperture of the first bracket and the aperture of the second bracket to rotationally couple the first bracket and the second bracket when the universal mounting structure is in a first orientation and the second pin is configured to be received through the second aperture of the first bracket and the aperture of the second bracket to rotationally couple the first bracket and the second bracket when the universal mounting structure is in a second orientation.

18. The kit of claim 17, wherein at least one universal mounting structure includes a first universal mounting structure and a second universal mounting structure.

19. The kit of claim 18, further comprising an elongated flexible striper blade having an upper edge and a lower edge opposite the upper edge.

20. The kit of claim 19, further comprising an L-shaped bracket, wherein a first portion of the L-shaped bracket is configured to be coupled to the upper edge of the striper blade, and a second portion of the L-shaped bracket is configured to be coupled to each of the third brackets of the first and second universal mounting structures.
